(19) United States
(12) Patent Application Publication
(10) Pub. No.: US 2003/0220723 A1
(43) Pub. Date: Nov. 27, 2003

(54) Apparatus system and method for remotely controlling a vehicle over a peer-to-peer network

(76) Inventors: Victor G. Bonilla, Scottsdale, AZ (US); James W. McCabe, Scottsdale, AZ (US)

Correspondence Address: KUNZLER & ASSOCIATES, 10 WEST 100 SOUTH, SUITE 450, SALT LAKE CITY, UT, 84101, US

(21) Appl. No.: 10/356,344

(22) Filed: Jan. 31, 2003

Related U.S. Application Data
(60) Provisional application No. 60/353,642, filed on Jan. 31, 2002.
(60) Provisional application No. 60/374,440, filed on Apr. 22, 2002.

(51) Int. Cl. G06F 7/00

(52) U.S. Cl. 701/2; 701/1

(57) ABSTRACT

A system and method are used for controlling a vehicle remotely over a peer-to-peer network. A vehicle is provided with a vehicle control module configured to transmit and receive network communications containing vehicle control data. In one embodiment, the vehicle control module is configured to transmit and receive network switched packets wirelessly. Additionally, the vehicle may be provided with one or more cameras configured to transmit a two dimensional, three dimensional, or 360° panoramic view from the vehicle. The peer-to-peer network comprises a user interface apparatus, and one vehicle to be controlled. The user interface apparatus may be configured to resemble a steering wheel commonly used with computer game systems. Alternatively, the user interface apparatus may be configured with either control joysticks or miniature control wheels.

### RELATED APPLICATIONS

This application is a Continuation-In-Part of and claims priority to U.S. Provisional Patent Application Serial No. 60/353,642, filed on Jan. 31, 2002 for Racing Visions, L.L.C., and for Provisional Patent Application Serial No. 60/374,440 filed on Apr. 22, 2002 for Racing Visions, L.L.C.

### BACKGROUND OF THE INVENTION

1. The Field of the Invention

The invention relates to remotely controlled vehicles, and more specifically, to apparatus systems and methods of remotely controlling a mobile vehicle over a network.

2. The Relevant Art

Remotely controlling scaled vehicles has been a popular hobby for many years. Children and adults are fascinated by the opportunity to control vehicles that normally are not available for use, such as military vehicles or trains. Scale replicas of racecars, boats, submarines, dune buggies, monster trucks, and motorcycles are among the vehicles that are widely available for remote control enthusiasts.

Modelers and manufacturers of scaled vehicles put forth considerable time and effort to attain a scaled vehicle with a life-like appearance. For many, great pleasure is derived from controlling a realistically scaled vehicle. Many methods have been developed to control scaled vehicles. Control mechanisms exist that utilize a physical connection, such as a cable, between the vehicle and the vehicle control module. This simple control mechanism is relatively inexpensive and easy to implement but requires that the user follow the vehicle. To overcome these limitations, radio control, or “R/C”, mechanisms have been developed.

Radio controllers facilitate the control of a vehicle through radio transmissions. By breaking the physical link between the vehicle and controller, R/C enthusiasts are able to participate in organized group events such as racing or with friends in what is known as “backyard bashing.” Additionally, R/C controllers have allowed scaled vehicles to travel over and under water, and through the air, which for obvious reasons was not previously possible with a cabled control mechanism.

Racing scaled versions of NASCAR™, Formula 1™, and Indy™ series racecars has become very popular because, unlike other sports, the public generally does not have the opportunity to race these cars. Although scaled racecars give the hobbyist the feeling of racing, for example, a stock car, remotely racing a scaled racecar may lack realism. In order to make a racecar visually interesting to the point of view of the racer, the racecar is normally operated at speeds that if scaled are unrealistic. Additionally R/C is limited by the amount of channels or frequencies available for use. Currently, operators of racing tracks or airplane parks must track each user's frequency and when all of the available channels are being used, no new users are allowed to participate.

A solution to this problem has been to assign a binary address to each vehicle in a system. Command data is then attached to the binary address and transmitted to all vehicles in the system. In an analog R/C environment, commands to multiple vehicles must be placed in a queue and transmitted sequentially; this presents a slight lag between a user control and response by the vehicle. Each vehicle constantly monitors transmitted commands and waits for a command with the assigned binary address. Limitations to this system include the loss of fine control of vehicles due to transmit lag, and ultimately the number of vehicles is limited because the time lag could become too great.

Accordingly, it is apparent that a need exists for an improved system of controlling multiple vehicles in a racing environment with increased support for fine-tuned control capabilities. A need also exists for simultaneously controlling multiple scaled vehicles in a racing environment and simulating full scale racing in a realistic manner.

### BRIEF SUMMARY OF THE INVENTION

The present invention includes a remotely controllable vehicle that may be controlled by a user in a peer-to-peer networking environment. The vehicle comprises a chassis configured to move about in response to vehicle control data from a user, a controller residing within the chassis configured to receive network switched packets containing the vehicle control data from a user in the peer-to-peer network, and an actuator interface module configured to operate an actuator in response to the vehicle control data received by the controller. The controller may be configured to transmit vehicle data feedback to a user.

In one embodiment, the controller is configured to transmit visual data to the user. Under a preferred embodiment of the present invention, the controller is configured to transmit a two dimensional, three dimensional, or 360° three dimensional view to the user. Additionally, the controller further comprises a wireless network interface connection.

In one embodiment, the present invention may comprise a handheld control apparatus from which a vehicle is remotely controlled in a peer-to-peer networking environment. The handheld control apparatus comprises a vehicle control module configured to generate vehicle control data in response to input from a user, and a transmission module configured to communicate with the vehicle control module and transmit network switched packets containing the vehicle control data over a transmission medium to the vehicle. In one embodiment of the present invention, the transmission medium comprises a wireless peer-to-peer network.

Additionally, the handheld control apparatus may comprise a video screen configured to display a portion or all of a two dimensional, three dimensional, or 360° panorama view selectable by the user. The handheld control apparatus also may comprise a joystick configured to generate vehicle control data. Alternatively, the handheld control apparatus may comprise a miniature wheel configured to generate vehicle control data. In an alternative embodiment, the handheld control apparatus may comprise a steering wheel configured to generate vehicle control data.

A control apparatus residing in a vehicle controllable remotely over a peer-to-peer network may be provided. The control apparatus may comprise a network interface connection configured to transmit and receive vehicle control data, a central processing unit configured to provide vehicle control data to the network interface connection, and an actuator interface module configured to receive vehicle control data from the central processing unit. Additionally, the control apparatus may further comprise a video interface module configured to communicate visual data to the central processing unit.

In one embodiment, the control apparatus comprises one or more video cameras configured to provide visual data to the video interface module. The video interface module may be configured to transmit a two dimensional, three dimensional, or 360° three dimensional view. Additionally, the control apparatus may comprise a Simple Network Management Protocol (SNMP) interface module residing within the central processing unit configured to operate an actuator. Alternately, the apparatus may be employed using a web-based protocol, such as Java™.

In one embodiment of the present invention, a peer-to-peer network for communicating with a vehicle operating under remote control is provided. In a further embodiment, the peer-to-peer network may comprise a handheld control apparatus, a network interface connection residing within the handheld control apparatus, and a central processing unit of a mobile vehicle over the network. The network interface connection may comprise a wireless network connection configured to transmit and receive network switched packets.

The present invention may also comprise a method of controlling a mobile vehicle over a peer-to-peer network, including but not limited to a LAN, WAN, satellite, and digital cable networks. In one embodiment of the present invention, the method may comprise providing a mobile vehicle configured to transmit and receive vehicle control data over the network, providing a handheld control apparatus configured to transmit and receive vehicle control data over a peer-to-peer network, transmitting vehicle control data, controlling the mobile vehicle in response to the transmitted vehicle control data, and receiving vehicle feedback data from the vehicle.

Additionally, transmitting vehicle control data may comprise transmitting network switched packets. In one embodiment, the vehicle feedback data may comprise vehicle performance parameters such as speed, revolutions per minute (RPM), engine temperature, visual data, audible data, and the like.

In a further embodiment of the present invention, a computer usable medium readable by a computer may be provided. The computer usable medium comprises tangibly embodying a program of instructions executable by a computer to perform a method for controlling a mobile vehicle over a peer-to-peer network. The method may comprise transmitting vehicle control data over a digital peer-to-peer network, controlling the vehicle using the control data, and receiving vehicle feedback data from the vehicle.

These features and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of one embodiment of a peer-to-peer network controlled vehicle of the present invention.

FIG. 2a is a schematic block diagram illustrating one embodiment of a two dimensional video camera module of the present invention.

FIG. 2b is a schematic block diagram illustrating one embodiment of a three dimensional video camera module of the present invention.

FIG. 2c is a schematic block diagram illustrating one embodiment of a 360° three dimensional video camera module of the present invention.

FIG. 3a is a schematic block diagram illustrating one embodiment of a vehicle control data packet.

FIG. 3b is a schematic block diagram illustrating one embodiment of a vehicle feedback data packet.

FIG. 4 is a schematic block diagram illustrating one embodiment of a vehicle control module of the present invention.

FIG. 5 is a schematic block diagram illustrating one embodiment of a remote vehicle control apparatus of the present invention.

FIG. 6 is a schematic block diagram illustrating one embodiment of a peer-to-peer network of the present invention for controlling a vehicle remotely.

FIG. 7 is a flow chart diagram illustrating one embodiment of a method of the present invention for controlling a vehicle remotely over a peer-to-peer network.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

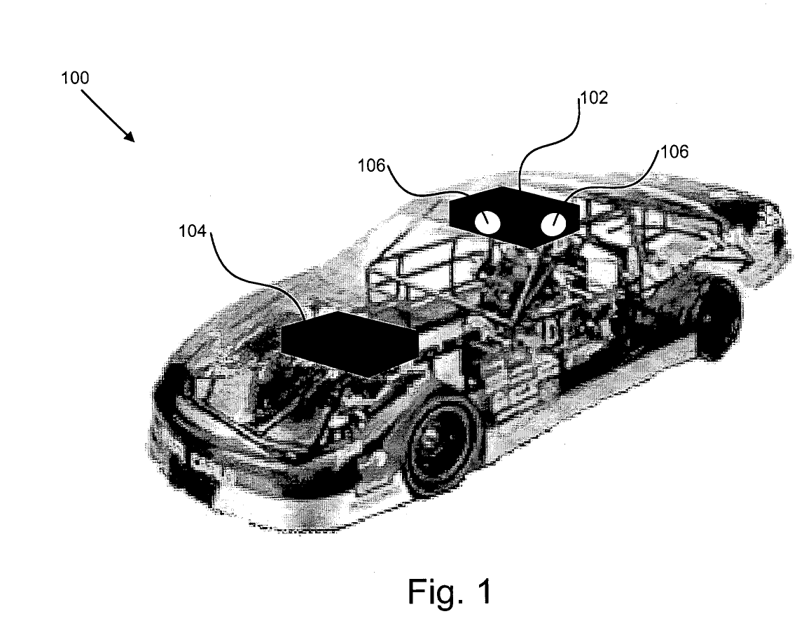

FIG. 1 shows a vehicle 100 that is controllable over a network. As depicted, the vehicle 100 comprises a video camera module 102 and a vehicle control module 104. The vehicle 100 is in one embodiment replicated at one-quarter scale, but may be of other scales also, including one-tenth scale, one-fifth scale, and one-third scale. Additionally, the network controlled vehicle 100 may embody scaled versions of airplanes, monster trucks, motorcycles, boats, buggies, and the like. In one embodiment, the vehicle 100 is a standard quarter scale vehicle 100 with centrifugal clutches and gasoline engines, and all of the data for the controls and sensors are communicated across the local area network. Alternatively, the vehicle 100 may be electric or liquid propane or otherwise powered. Quarter scale racecars are available from New Era Models of Nashua, N.H. as well as from other vendors, such as Danny's ¼ Scale Cars of Glendale, Ariz.

The vehicle 100 is operated by remote control and in one embodiment an operator need not be able to see the vehicle 100 to operate it. Rather, a video camera module 102 is provided with one or more cameras 106 connected to the vehicle control module 104 for displaying the points of view of the vehicle 100 to an operator. The operator may control the vehicle 100 from a remote location at which the operator receives vehicle control data and optionally audio and streaming video. In one embodiment, the driver receives the vehicle control data over a local area network. Under a preferred embodiment of the present invention, the video camera module 102 is configured to communicate to the operator using the vehicle control module 104. Alternatively, the video camera module 102 may be configured to transmit streaming visual data directly to an operator station.

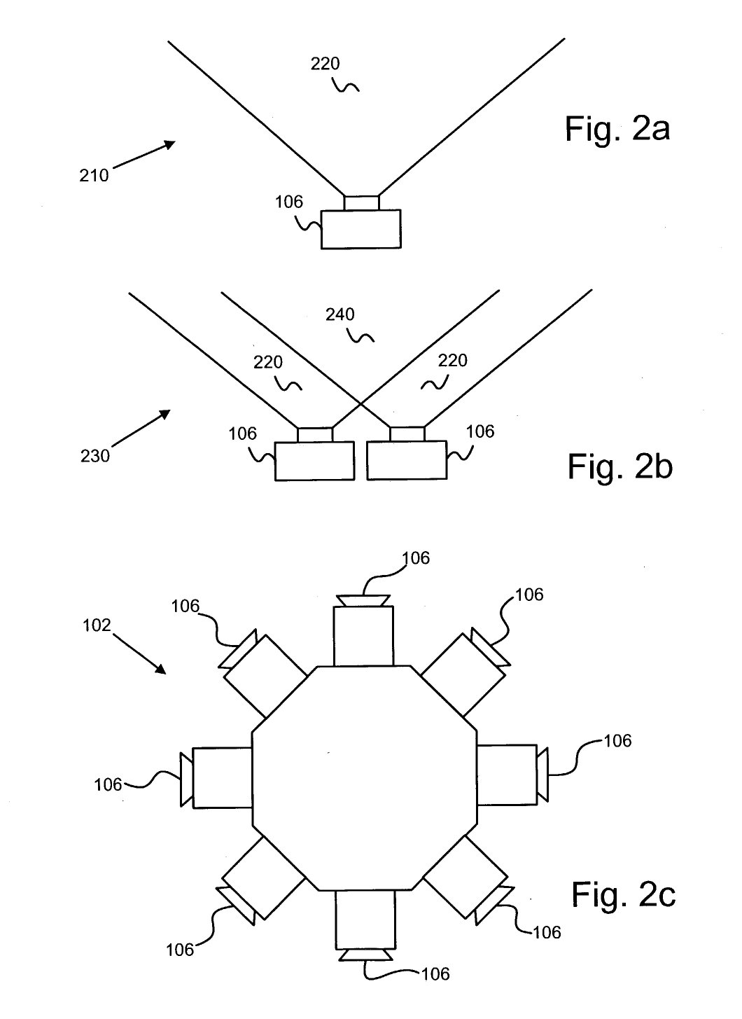

FIG. 2a depicts a plan view 210 of a single camera 106 that may be mounted to the vehicle 100 as discussed in conjunction with FIG. 1. The depicted camera 106 has a specific field of view 220, delineated by pair of the angled solid lines, that is determined by the design and manufacture of the camera 106. In one embodiment, the field of view 220 is fixed and, in an alternate embodiment, the field of view 220 of the camera 106 may be dynamically adjusted using either optical or digital processes. The field of view 220 captured by the illustrated camera 106 generally produces a two dimensional image.

FIG. 2b illustrates a plan view 230 of a pair of cameras 106 that may be co-mounted to the vehicle 100. As in the previous figure, each depicted camera 106 has a specific field of view 220. Similarly, the field of view 220 of each camera 106 in the pair may be fixed or dynamically adjustable. According to the mounting configuration, including the relational orientation of the pair of cameras 106, the fields of view 220 may wholly or partially overlap. The video camera module 102 may then process the combination of captured fields of view 220 and create a three dimensional image.

Referring now to FIG. 2c, shown therein is one embodiment of the video camera module 102. The video camera module 102 comprises a plurality of video cameras 106. The cameras 14 may be mounted in a ring so as to provide a combined panoramic view created from the plurality of corresponding fields of view 220. One advantage of the present invention is the ability to form a two dimensional, three dimensional, or 360° three dimensional image. The video camera module 102 is preferably configured to weave the overlapping fields of view 220 of each camera 106. As discussed in conjunction with FIG. 2b, a three dimensional view is possible by processing two overlapping fields of view 220. Each camera 106 may be oriented to allow overlap of the fields of view 220 of the two cameras 106 that are closest.

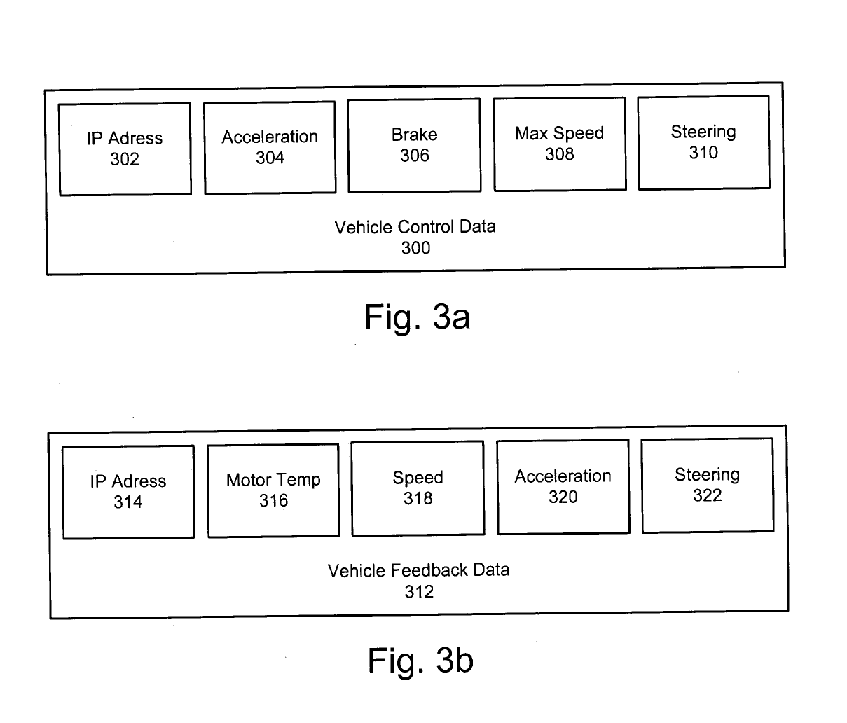

FIG. 3a illustrates one embodiment of vehicle control data 300. Under a preferred embodiment of the present invention, the vehicle control data 300 may comprise one or more network switchable packets. Preferably, the vehicle control data 300 contains an internet protocol (IP) address 302, an acceleration setting 304, a brake setting 306, a maximum speed setting 308, and a steering setting 310 of course not all of this data need be present, and other data may also be transmitted in the packet(s). The IP address 302 enables correct routing of the vehicle control data 300 between a user and the vehicle 100. IP addressing and the details thereof are well known to those skilled in the art.

In one embodiment a single packet of vehicle control data 300 may contain various setting data including, for example the acceleration setting 304, the brake setting 306, the maximum speed setting 308, and the steering setting 310. Alternatively, each vehicle control data 300 packet may contain only one setting to be updated. The manner in which the vehicle control data 300 is utilized will be discussed in greater detail below.

Referring now to FIG. 3b, shown therein is one embodiment of vehicle feedback data 312. The vehicle feedback data 312 is configured in a manner substantially equivalent to the vehicle control data 300. In one embodiment, the vehicle feedback data 312 contains at least an IP address 314. Alternatively, the vehicle feedback data 312 comprises one or more of a motor temperature 316, a speed 318 at which the vehicle 100 is traveling, an acceleration 320 of the vehicle 100, and a steering position 322. In alternative embodiments, the settings 316, 318, 320, 322 may comprise data such as a list of envirormental variables or performance parameters of the vehicle 100 as selected by a user.

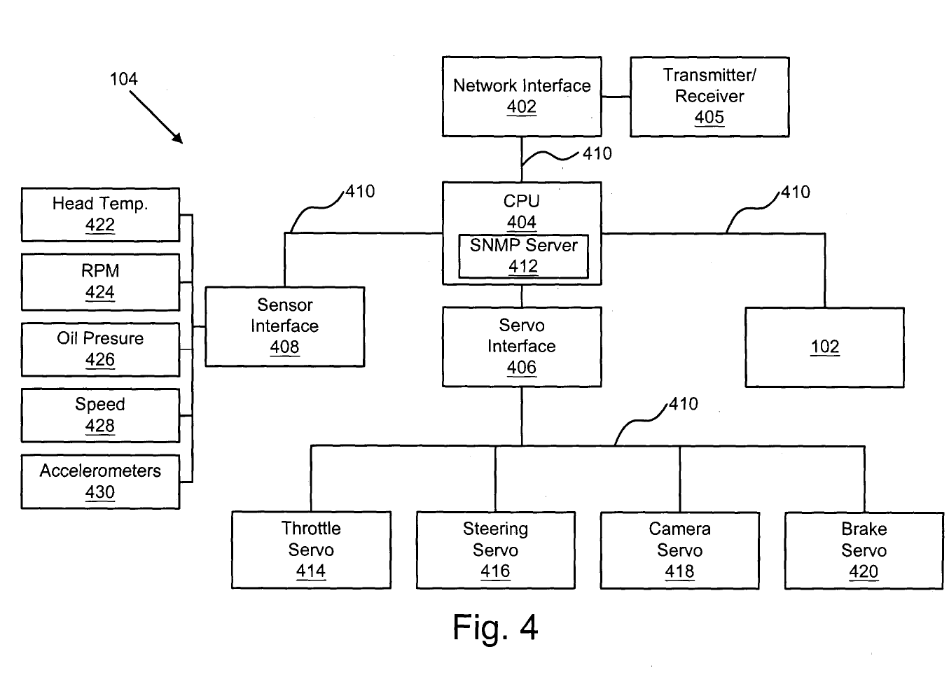

FIG. 4 shows one embodiment of the vehicle control module 104. The vehicle control module 104 preferably comprises a network interface module 402, a central processing unit (CPU) 404, a servo interface module 406, a sensor interface module 408, and the video camera module 102. In one embodiment, the network interface module 402 is provided with a wireless transmitter and receiver 405. The transmitter and receiver 405 may be custom designed or may be a standard, off-the-shelf component such as those found on laptops or electronic handheld devices. Indeed, a simplified computer similar to a Palm™ or Pocket PC™ may be provided with wireless networking capability, as is well known in the art and placed in the vehicle 100 for use as the vehicle control module 104.

In one embodiment of the present invention, the CPU 404 is configured to communicate with the servo interface module 406, the sensor interface module 408, and the video camera module 102 through a data channel 410. The various controls and sensors may be made to interface through any type of data channel 410 or communication ports, including PCMCIA ports. The CPU 404 may also be configured to select from a plurality of performance levels upon input from an administrator received over the network. Thus, an operator may use the same vehicle 100 and may progress from lower to higher performance levels. The affected vehicle 100 performance may include steering sensitivity, acceleration, and top speed. This feature is especially efficacious in driver education and training applications. The CPU 404 may also provide a software failsafe with limitations to what an operator is allowed to do in controlling the vehicle 100.

In one embodiment, the CPU 404 comprises a Simple Network Management Protocol (SNMP) server module 412. SNMP provides an extensible solution with low computing overhead to managing multiple devices over a network. SNMP is well known to those skilled in the art. In an alternate embodiment not depicted, the CPU 404 may comprise a web-based protocol server module configured to implement a web-based protocol, such as Java™, for network data communications.

The SNMP server module 412 is configured to communicate vehicle control data 300 to the servo interface module 406. The servo interface module 406 communicates the vehicle control data 300 with the corresponding servo. For example, the network interface card 402 receives vehicle control data 300 that indicates a new position for a throttle servo 414. The network interface card 402 communicates the vehicle control data 300 to the CPU 404 which passes the data 300 to the SNMP server 412. The SNMP server 412 receives the vehicle control data 300 and routes the setting that is to be changed to the servo interface module 406. The servo interface module 406 then communicates a command to the throttle servo 414 to accelerate or decelerate.

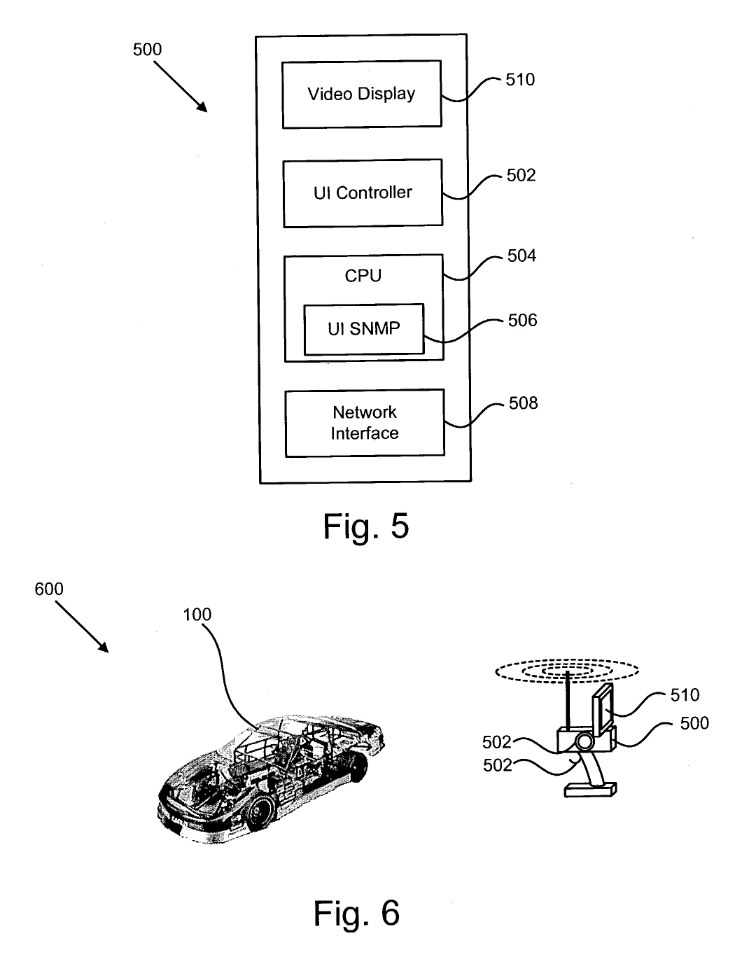

Referring now to FIG. 5, shown therein is one embodiment of a user interface (UI) apparatus 500 for communicating with a vehicle operating under remote control. The UI apparatus 500 comprises a UI controller 502, a CPU 504, a UI SNMP module 506, and a network interface connection 508. In one embodiment of the present invention, the UI apparatus 500 may comprise a portable control device configured with a steering wheel controller, such as the Thrustmaster™ controller used for video games. In an alternative embodiment, the UI apparatus 500 may be configured in a manner patterned after traditional remote hand-held controllers.

The UI controller 502 is preferably configured to convert command data 300 from the user into data recognizable by the CPU 504 and the UI SNMP module 506. In one embodiment of the present invention, the CPU 504 is configured to communicate with the UI controller 502, the UI SNMP module 506, and the network interface connection 508. The input received from the user through the UI controller 502 is configured by the CPU 504 and the UI SNMP module 506 in order to be transmitted by the network interface 508 to the car 100 through a transmission medium (not shown).

In one embodiment, the transmission medium comprises a standard Ethernet network, which is familiar to one skilled in the art. Under a preferred embodiment of the present invention, the transmission medium may comprise a wireless peer-to-peer network 600.

Referring now to FIG. 6, shown therein is one embodiment of a wireless peer-to-peer network 600 of the present invention. The configuration of the peer-to-peer network 600 is given herein by way of example and is not limiting as one skilled in the art can readily modify the configuration while maintaining the intention of the network 600. Due to the peer-to-peer network 600 configuration, multiple vehicles 100 and UI apparati 500 need not be run on different frequencies. The IEEE 802.11 protocol provides multiple hardware addresses for a plurality of devices, or vehicles 100. A property of the network 600 is the ability to support multiple devices. Therefore, it is possible under the present invention to overcome limitations in the prior art regarding the number of radio frequencies available for use.

In one embodiment, both audio/video signals and control signals may transmitted over the wireless transmission medium using the 802.11 protocol or Bluetooth or another appropriate transmission protocol. However, in alternative embodiments, the control signals may be transmitted with one protocol or transmission type and the audio and video signals with another. Alternatively, vehicle control data may be embedded on a monaural channel of a video signal (i.e., in between the upper and lower channels). This signal then may be transmitted as the control signals of the vehicle 100. Control signals may also be transmitted from the vehicle 100 in addition to the audio and visual data transmitted by the video camera module 102. Such signals may be used to generate a display to be shown on the video display 510, including in one embodiment a heads up display, for the user. Thus, gauges or other displays may show speed, fuel, oil pressure, temperature, etc.

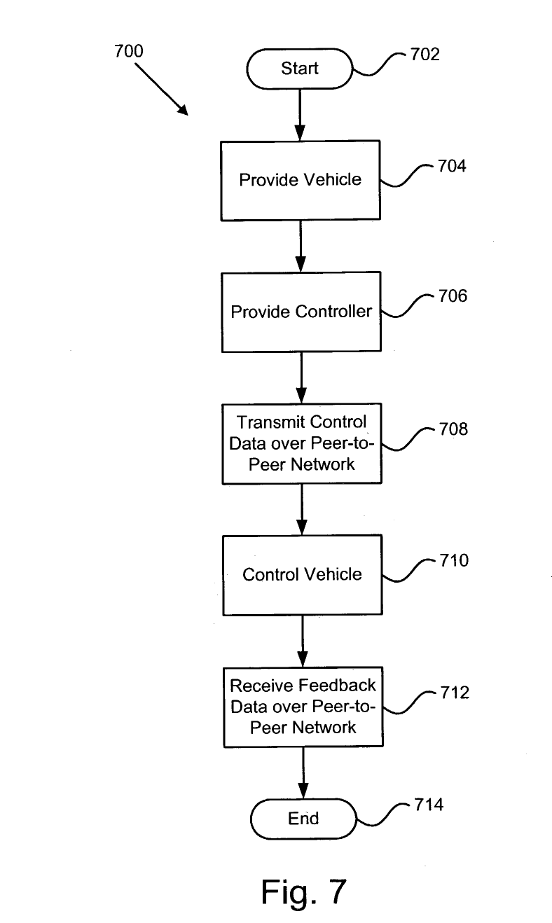

Referring now to FIG. 7, shown therein is a method 700 of controlling a vehicle over a network 600. The method 700 starts 702as the vehicle 100 is provided 704. Under one embodiment of the present invention, the vehicle 100 is a gas powered vehicle 100. Alternatively, the vehicle 100 may be powered by electricity or liquid propane fuel or otherwise powered. The peer-to-peer network 600 is then provided 706. In one embodiment the peer-to-peer network 600 is provided 706 with the vehicle 100 and the UI apparatus 500.

Vehicle control data 300 is then generated by a user and transmitted 708 over the peer-to-peer network 600. The vehicle control data 300 may be transmitted 708 wirelessly and also possibly through standard network data channels. The vehicle 100 receives the vehicle control data 300 and the vehicle 100 is controlled 710 in response to the vehicle control data 300. Upon request, or at scheduled intervals the vehicle 100 transmits feedback data 312, and the UI apparatus 500 receives 712 the feedback data over the peer-to-peer network 600. The feedback data or portions of it may then e displayed for a user. The method 700 continues until the user terminates 714.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A vehicle controllable to move in a manner selectable remotely by a user in a peer-to-peer networking environment, the vehicle comprising:
a chassis configured to move in response to vehicle control data from a user;
a vehicle control module residing within the chassis configured to receive network switched packets containing the vehicle control data from a user in the peer-to-peer network; and
an actuator interface module configured to operate an actuator in response to the vehicle control data received by the vehicle control module.

2. The vehicle of claim 1, wherein the vehicle control module is configured to transmit vehicle data feedback to a user.

3. The vehicle of claim 1, wherein the vehicle control module is configured to transmit visual data to the user.

4. The vehicle of claim 1, wherein the vehicle control module is configured to transmit a 360° three dimensional view to the user.

5. The vehicle of claim 1, wherein the actuator comprises a servo motor.

6. The vehicle of claim 1, wherein the vehicle control module further comprises a wireless network interface connection.

7. A handheld control apparatus from which a vehicle is remotely controlled in a peer-to-peer networking environment, the apparatus comprising:
a vehicle control module configured to generate vehicle control data in response to input from a user; and
a transmission module configured to communicate with the vehicle control module and transmit network switched packets containing the vehicle control data over a transmission medium to the vehicle.

8. The handheld control apparatus of claim 7, wherein the transmission medium comprises a wireless peer-to-peer network.

9. The handheld control apparatus of claim 7, further comprising a video screen configured to display a 360° three dimensional view.

10. The handheld control apparatus of claim 9, wherein the video screen is configured to display a portion of the 360° three dimensional view selectable by the user.

11. The handheld control apparatus of claim 7, wherein the vehicle control module comprises a joystick configured to generate vehicle control data.

12. The handheld control apparatus of claim 7, wherein the vehicle control module comprises a miniature wheel configured to generate vehicle control data.

13. The handheld control apparatus of claim 7, wherein the vehicle control module comprises a steering wheel configured to generate vehicle control data.

14. A control apparatus for a vehicle controllable remotely over a peer-to-peer network, the apparatus comprising:
a network interface connection configured to transmit and receive vehicle control data;
a central processing unit configured to provide vehicle control data to the network interface connection; and
an actuator interface module configured to receive vehicle control data from the central processing unit.

15. The control apparatus of claim 14, further comprising a video interface module configured to communicate visual data to the central processing unit.

16. The control apparatus of claim 15, further comprising a video camera configured to provide visual data to the video interface module.

17. The control apparatus of claim 15, wherein the video interface module is configured to transmit a 360° three dimensional view.

18. The control apparatus of claim 14, further comprising a Simple Network Management Protocol (SNMP) interface module residing within the central processing unit and configured to operate an actuator.

19. The control apparatus of claim 14, further comprising a web-based interface module residing within the central processing unit and configured to operate an actuator.

20. A peer-to-peer network for communicating with a vehicle operating under remote control, the network comprising:
a handheld control apparatus;
a network interface connection residing within the handheld control apparatus; and
a user interface vehicle control module configured to communicate over the network with a central processing unit of a remotely controlled vehicle.

21. The peer-to-peer network of claim 20, wherein the network interface connection comprises a wireless network connection configured to transmit and receive network switched packets.

22. A method of controlling a mobile vehicle over a network, comprising:
providing a vehicle control module configured to transmit and receive vehicle control data over the network;
providing a handheld control apparatus configured to transmit and receive vehicle control data over the network;
transmitting vehicle control data;
controlling the mobile vehicle in response to the transmitted vehicle control data; and
receiving vehicle feedback data from the vehicle.

23. The method of claim 22, wherein transmitting vehicle control data further comprises transmitting network switched packets.

24. The method of claim 22, wherein the vehicle feedback data comprises vehicle performance parameters including speed, revolutions per minute (RPM), engine temperature, visual data, audible data.

25. A computer usable medium readable by a computer, tangibly embodying a program of instructions executable by a computer to perform a method for controlling a mobile vehicle over a peer-to-peer network, the method comprising:
transmitting vehicle control data over a digital peer-to-peer network;
controlling the vehicle using the control data; and
receiving vehicle feedback data from the vehicle.

26. A mobile vehicle controllable over a network, the vehicle comprising:
means for moving the vehicle in response to vehicle control data from a user;
means for transmitting and receiving network switched packets containing the vehicle control data over a peer-to-peer network; and
means for operating an actuator in response to the received vehicle control data.
